(19) United States
(12) Patent Application Publication
(10) Pub. No.: US 2022/0112855 A1
(43) Pub. Date: Apr. 14, 2022

(54) Leakage Detector for Fuel Vapor Treatment Device

(71) Applicant: AISAN KOGYO KABUSHIKI KAISHA, Obu-shi, (JP)

(72) Inventors: Mariko KAWASE, Funabashi-shi (JP); Yuya TANIDA, Obu-shi (JP); Masanobu SHINAGAWA, Nagoya-shi (JP)

(73) Assignee: AISAN KOGYO KABUSHIKI KAISHA, Obu-shi (JP)

(21) Appl. No.: 17/487,274

(22) Filed: Sep. 28, 2021

(30) Foreign Application Priority Data
Oct. 14, 2020 (JP) 2020-173276

(51) Int. Cl. F02D 41/22; F02M 35/10; F02M 25/08; B60K 15/03; F02D 41/00; B01D 53/04

(52) U.S. Cl. CPC F02D 41/22; B01D 2259/4566; F02M 25/08; B60K 15/03; F02D 41/003; B01D 53/0415; F02D 2041/225; F02D 2200/0606; F02D 2200/0602; B60K 2015/03243; B60K 2015/0321; B01D 2253/102; B01D 2257/702; B01D 2259/4516; F02M 35/10222

(57) ABSTRACT

A leakage detector for fuel vapor treatment device is configured to diagnose a leakage of a fuel vapor in a vapor path based on an internal pressure change of the vapor path with the vapor path functioning as a closed space. The leakage detector performs the leakage diagnosis of the vapor path by correcting the effect of the pressure of the fuel vapor with regards to the internal pressure change. The leakage detector comprises a vaporization promoting device and is configured to determine whether the fuel vapor in the gas space of a fuel pump has reached a saturated state.

### CROSS-REFERENCE TO RELATED APPLICATIONS

This application claims priority to Japanese patent application serial number 2020-173276, filed Oct. 14, 2020, the content of which is hereby incorporated herein by reference in its entirety for all purposes.

### BACKGROUND

This disclosure relates generally to leakage detectors for fuel vapor treatment devices.

A vehicle utilizing fuel, such as gasoline, is often equipped with a fuel vapor treatment device that captures fuel vapor generated in a fuel tank by adsorbing the fuel vapor in a canister. The fuel vapor treatment device purges the fuel vapor captured in the canister when the engine of the vehicle is running. Some fuel vapor treatment devices are equipped with a leakage detector that automatically determines the presence or absence of leakage in a vapor path confining the fuel vapor. In the leakage diagnosis system, for example, the vapor path that confines the fuel vapor is set to a predetermined negative pressure, and a valve configured to isolate the vapor path from an external space is closed. Then, the presence or absence of leakage is diagnosed by determining whether there is a subsequent increase in pressure in the vapor path.

In the leakage diagnosis, changes in pressure are caused not only by the presence of leakage, but also by changes in a vapor pressure of the fuel vapor. The vapor pressure of the fuel vapor varies depending on the fuel temperature and fuel properties. Therefore, the reference value for leakage detection is corrected based on the fuel temperature and fuel properties (see Japanese Laid-Open Patent Publication No. H06-235354 and Japanese Patent Registration No. 5318793).

### SUMMARY

In accordance with an aspect of the present disclosure, a first embodiment may include a leakage detector for a fuel vapor treatment device comprises a fuel tank, a canister, and a vapor path. The vapor path may include the fuel tank and the canister, and may confine the fuel vapor from the atmosphere. In the fuel vapor treatment device, the fuel vapor in the fuel tank may be adsorbed and captured in the canister. The captured fuel vapor may be sucked into an engine or returned to the fuel tank. The presence or absence of the leakage of the fuel vapor in the vapor path may be diagnosed based on the internal pressure change of the vapor path when the vapor path is functioning as a closed space. Moreover, the leakage detector may perform the leakage diagnosis of the vapor path by correcting the effect of the pressure of the fuel vapor with regards to the internal pressure change. The leakage detector for the fuel vapor treatment device may further comprise a vaporization promoting means and a saturation detection means. The vaporization promoting means may be configured to promote vaporization of the fuel in the fuel tank. The saturation detection means may determine whether the fuel vapor in the fuel tank has reached the saturated state. If the saturation detection means determines that the fuel vapor has not reached the saturated state, the vaporization promoting means is activated. The leakage diagnosis of the vapor path may be performed after determining that the fuel vapor has reached the saturated state by the saturation detection means.

Since the leakage diagnosis of the vapor path is performed after determining that the fuel vapor has reached the saturated state, the diagnostic accuracy may be improved. Moreover, since the vaporization of the fuel is accelerated by the vaporization promoting means, the time required to reach the saturation state may be shortened, and the leakage diagnosis may be completed earlier.

In accordance with another aspect of the present disclosure, a second embodiment may be a leakage detector for the fuel vapor treatment device according to the first embodiment, wherein the saturation state may be determined by the saturation detection means based on physical characteristics that change with the promotion of the fuel vaporization in the fuel tank.

In the second embodiment, the physical characteristics may be, for example, the pressure of the fuel vapor or the concentration of the fuel vapor.

According to the second embodiment, the saturation state may be determined by the saturation detection means with a simple configuration.

In accordance with another aspect of the present disclosure, a third embodiment may be a leakage detector for the fuel vapor treatment device according to the second embodiment, wherein the leakage detector may include a pressure sensor that detects the pressure in the gas space of the fuel tank. The saturation detection means compares the rate of the pressure change detected by the pressure sensor with the target rate of the pressure change. If the difference between the two is within a threshold value for more than a predetermined time, it is determined that the fuel vapor is in a saturated state.

According to the third embodiment, by utilizing the detection results of the pressure sensor, which is also used for other purposes, it is possible to accurately determine the saturation state by the saturation detection means with a simple configuration.

In accordance with another aspect of the present disclosure, a fourth embodiment may be a leakage detector for the fuel vapor treatment device according to the third embodiment, further comprising a temperature sensor that detects the temperature of the fuel vapor in the gas space of the fuel tank. A target rate of the pressure change of the fuel vapor may be set using the saturated vapor pressure characteristic, which represents the change of the fuel vapor pressure with regards to the temperature change when the fuel vapor in the fuel tank is in the saturated state, and the temperature change detected by the temperature sensor.

According to the fourth embodiment, by utilizing the detection results of the temperature sensor, which is also used for other purposes, it is possible to set the target rate of the pressure change in the saturation detection means with a simple configuration.

In accordance with another aspect of the present disclosure, a fifth embodiment may be a leakage detector for the fuel vapor treatment device according to the fourth embodiment, wherein the leakage detector further comprises a fuel pump and an aspirator. The fuel pump may supply fuel from the fuel tank to the engine. The aspirator may cause the fuel from the fuel pump to flow at an increased flow rate to a narrow channel whose passage cross-sectional area is narrower than that of the upstream side. Thereby, a negative pressure may be generated in the decompression chamber around the narrow channel by the Venturi effect. The saturated vapor pressure characteristic may be estimated using the pressure of the fuel vapor in the saturated state obtained by the internal pressure in the decompression chamber of the aspirator and the temperature detected by the temperature sensor.

According to the fifth embodiment, the pressure of the fuel vapor in the saturated state may be easily obtained since the pressure of the fuel vapor in the saturated state may be easily obtained from the pressure of the decompression chamber of the aspirator.

In accordance with another aspect of the present disclosure, a sixth embodiment may be a leakage detector for the fuel vapor treatment device according to the fourth embodiment, wherein the saturated vapor pressure characteristic may be estimated by using the temperature detected by the temperature sensor and the pressure detected by the pressure sensor, and by comparing the pressure change associated with the temperature change of the fuel vapor in the gas space of the fuel tank with a plurality of saturated vapor pressure characteristics stored in advance.

According to the sixth embodiment, the saturated vapor pressure characteristic may be estimated only from the detection results of the temperature sensor and the pressure sensor, without using the aspirator.

In accordance with another aspect of the present disclosure, a seventh embodiment may be a leakage detector for the fuel vapor treatment device according to the first embodiment, wherein the saturation detecting means may determine whether the fuel vapor has reached the saturated state by determining whether a predetermined detecting time has elapsed since beginning the operation of the vaporization promoting means. The predetermined detecting time may be determined based on the output of the vaporization promoting means and the volume of the gas space of the fuel tank.

According to the seventh embodiment, the system configuration may be simplified because only time is used to determine whether the fuel vapor has reached the saturated state.

In accordance with another aspect of the present disclosure, an eighth embodiment may be a leakage detector for the fuel vapor treatment device according to any one of the first to seventh embodiments, further comprising a saturation maintenance detection means. The saturation maintenance determination means may determine whether the saturation state is maintained based on physical characteristics that vary depending on the state of fuel vaporization in the fuel tank. This determination may be done after the fuel vapor has been determined to be saturated by the saturation detection means. If the saturation state is determined not to be maintained by the saturation maintenance detection means, the vaporization promoting means may be activated.

In the eighth embodiment, the physical characteristics may be, for example, the pressure of the fuel vapor or the concentration of the fuel vapor.

According to the eighth means, if the fuel vapor returns to the non-saturated state again after having reaches the saturated state, the vaporization promoting means may be activated again by the saturation maintenance detection means. Therefore, the leakage diagnosis of the vapor path may be performed with high accuracy.

In accordance with another aspect of the present disclosure, a ninth embodiment may be a leakage detector for the fuel vapor treatment device according to any one of the first to eighth embodiments, wherein the vaporization promoting means comprises a pressure regulator. The surplus fuel of the fuel supplied from the fuel tank to the engine by the fuel pump is refluxed to the fuel tank by the pressure regulator.

According to the ninth embodiment, the leakage detector may be configured without complicating the system configuration since the vaporization promoting means is configures an existing pressure regulator.

In accordance with another aspect of the present disclosure, a tenth embodiment may be a leakage detector for the fuel vapor treatment device according to any one of the first to eighth embodiments, wherein the vaporization promoting means comprising an aspirator. The aspirator may cause the fuel supplied from the fuel tank to the engine by the fuel pump to flow through the narrow channel whose passage cross-sectional area is narrower than that of the upstream side and the downstream side at an increased flow rate and may be refluxed to the fuel tank. Thereby, a negative pressure may be generated in the decompression chamber around the narrow channel due to the Venturi effect.

According to the tenth embodiment, vaporization may be promoted efficiently by the aspirator. Further, in the case of a system already equipped with an aspirator, the leakage detector may be configured without complicating the system configuration.

In accordance with another aspect of the present disclosure, an eleventh embodiment may be a leakage detector for the fuel vapor treatment device according to any one of the third to sixth embodiments, wherein the leakage detector comprises a leakage detecting means which determines whether there is a leakage of evaporated fuel from the vapor path. This determination is done when the fuel vapor is a non-saturated state and whether the rate of the pressure change of the fuel vapor pressure detected by the pressure sensor remains below a certain value for a certain period of time.

According to the eleventh embodiment, if there is a leak due to a large hole in the vapor path, the leak may be detected without the need for leakage diagnosis by the leakage detecting means. Accordingly, an early leakage diagnosis may be performed. Therefore, it is possible to avoid unnecessarily operating the leakage diagnostic function.

### BRIEF DESCRIPTION OF THE DRAWINGS

FIG. 1 is a schematic view of an embodiment of a leakage detector for a fuel vapor treatment device in accordance with the principles described herein.

FIG. 2 is a block diagram of a control circuit for operating and controlling the leakage detector of FIG. 1.

FIG. 3 is an enlarged cross-sectional view of the aspirator of FIG. 1.

FIG. 4 is a flowchart illustrating an embodiment of a method for performing a leakage diagnostic routine of the control unit of FIG. 2 in accordance with the principles described herein.

FIG. 5 is a flowchart illustrating an embodiment of a method for performing a vaporization promotion and saturation determination routine of the control unit of FIG. 2 in accordance with the principles described herein.

FIG. 6 is a diagram illustrating the pressure in the decompression chamber of the aspirator of FIG. 1 as a function of the fuel flow rate in the aspirator.

FIG. 7 is a saturated vapor pressure diagram illustrating an embodiment of a method for estimating the saturated vapor pressure characteristics in accordance with principles described herein.

FIG. 8 is a diagram illustrating an embodiment of a method for determining the saturation of the fuel vapor in the gas space of the fuel tank of FIG. 1 in accordance with the principles described herein and in an exemplary case where a temperature of the gas space in the fuel tank is constant.

FIG. 9 is a diagram illustrating an embodiment of a method for determining the saturation of the fuel vapor in the gas space of the fuel tank of FIG. 1 in accordance with the principles described herein and in an exemplary case where the temperature of the gas space in the fuel tank gradually increases.

FIG. 10 is a flowchart illustrating an embodiment of a method for operating the control unit of FIG. 2 in accordance with principles described herein (note: FIG. 10 emphasizes the steps that are changed as compared to the embodiment shown in FIG. 5).

FIG. 11 is a diagram illustrating a pressure change in the gas space of the fuel tank of FIG. 1 as a function of a temperature change of the gas space of the fuel tank (note: FIG. 11 may be used for explaining an embodiment of an estimation method of saturated vapor pressure characteristics).

FIG. 12 is a saturated vapor pressure characteristics diagram (note: FIG. 12 may be used for explaining an embodiment of an estimation method of saturated vapor pressure characteristics).

FIG. 13 is a flowchart illustrating an embodiment of a method for operating the control unit of FIG. 2 (note: FIG. 13 emphasizes the steps that are changed as compared to the embodiment shown in FIG. 5).

### DETAILED DESCRIPTION

As previously described, the vapor pressure of the fuel vapor varies depending on the fuel temperature and fuel properties, and thus, the reference value for leakage detection is typically corrected based on the fuel temperature and fuel properties. However, in practice, the vapor pressure of the fuel vapor also varies based on the concentration of the fuel vapor. Therefore, the vapor pressure cannot be accurately estimated by only considering the fuel temperature and fuel properties.

Accordingly, an objective of the present disclosure is to improve the accuracy of leakage detection by suppressing changes in fuel vapor concentration. In one embodiment, this may be done by saturating the concentration of the fuel vapor during leakage detection in the fuel vapor treatment device.

In order to achieve the above objective, embodiments of the leakage detector for the fuel vapor treatment device disclosed herein may take the following configurations.

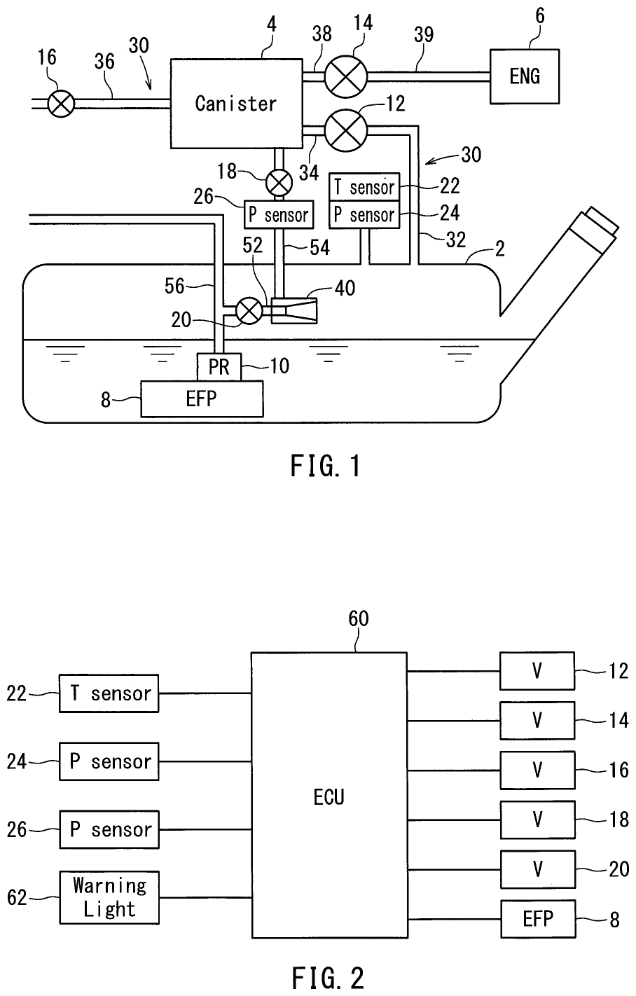

FIG. 1 shows an embodiment of a leakage detector for a fuel vapor treatment device. This embodiment is an example of application of the leakage detector to gasoline engines, diesel engines, or other engines.

In FIG. 1, an upstream vapor passage 32 is connected to a space above the fuel level (i.e., a gas space) of a fuel tank 2. The upstream vapor passage 32 transport fuel vapor in the gas space so that it may be adsorbed and captured by activated carbon (not shown) in a canister 4. One end of a downstream vapor passage 34 is connected to the canister 4. The other end of the downstream vapor passage 34 is connected to the upstream vapor passage 32 via a shutoff valve 12. Thus, fuel vapor in the gas space of the fuel tank 2 can be communicated to the canister 4 via passages 32, 34 and valve 12. One end of an atmospheric passage 36 is connected to the canister 4, and the other end of the atmospheric passage 36 is selectively opened and closed to the atmosphere via an atmospheric valve 16. Accordingly, the pressure of the fuel vapor in the gas space of the fuel tank 2 can become higher than atmospheric pressure (e.g., when the atmospheric valve 16 is closed). When the shutoff valve 12 and the atmospheric valve 16 are open, the fuel vapor in the fuel tank 2 can flow to the canister 4, where it is adsorbed and captured. An upstream purge passage 38 is connected to the canister 4 at a location adjacent to the downstream vapor passage 34. The other end of the upstream purge passage 38 is connected to a downstream purge passage 39 via a purge valve 14. An end of the downstream purge passage 39 is connected to an intake passage of an engine 6 (also referred to as “ENG” in the figures). When the engine 6 is running and the purge valve 14 and the atmospheric valve 16 are open, the fuel vapor, which has been adsorbed and captured in the canister 4, flows into the engine 6 due to the negative pressure of the suction air of the engine 6. The fuel vapor supplied to the engine 6 is then burned by the engine 6. A path through which the fuel vapor may flow, also referred to as a vapor path 30, includes the fuel tank 2, the canister 4, the upstream vapor passage 32, the downstream vapor passage 34, the atmospheric passage 36, the upstream purge passage 38, and the downstream purge passage 39. During a leakage diagnosis, the presence or absence of leakage from the vapor path 30 to the atmosphere can be detected.

A fuel pump 8 (also referred to as “EFP” in the figures) is secured at the bottom of the liquid area of the fuel tank 2. The liquid fuel in the fuel tank 2 can be supplied to the engine 6 via a fuel supply passage 56. The fuel pump 8 includes a pressure regulator 10 (also referred to as “PR” in the figures). A surplus of the fuel supplied by the fuel pump 8 to the engine 6 may be returned to the fuel tank 2 by the pressure regulator 10. A branch passage 52 extends from the fuel supply passage 56. A branch valve 20 is disposed along the branch passage 52. Surplus fuel may be supplied to an aspirator 40 (also referred to as “ASP” in the figures) via the branch passage 52. The aspirator 40 is positioned such that it is generally located in the gas space of the fuel tank 2 (i.e., above the liquid fuel in the gas tank 2). The aspirator 40 can generate a negative pressure by flowing fuel therethrough. One end of a suction passage 54 is connected to the aspirator 40, and the other end of the suction passage 54 is connected to the canister 4 at a location adjacent to the downstream vapor passage 34 and the upstream purge passage 38. A closing valve 18 is disposed along the suction passage 54. Thus, a negative pressure generated by the aspirator 40 can act on the suction passage 54, the canister 4, the downstream vapor passage 34, and the upstream purge passage 38. The suction passage 54 is provided with a pressure sensor 26 (also referred to as “P sensor” in the figures). The pressure sensor 26 detects and measures the pressure in the suction passage 54. The gas space of the fuel tank 2 is provided with a temperature sensor 22 (also referred to as “T sensor” in the figures) and a pressure sensor 24 (also referred to as “P sensor” in the figures). The temperature sensor 22 detect and measures the temperature of the fuel vapor in the gas space. The pressure sensor 24 detects and measures the pressure of the fuel vapor in the gas space.

FIG. 2 is a block diagram of a control circuit for operating and controlling the embodiment of the leakage detector of FIG. 1. The control circuit includes a control unit 60 comprising one or more processor. Detection signals from the temperature sensor 22 and the pressure sensors 24, 26 are communicated to the control unit 60. The control unit 60 outputs and communicates operation signals to the shutoff valve 12, the purge valve 14, the atmospheric valve 16, the closing valve 18, the branch valve 20, and the fuel pump 8 for controlling their operating states. Further, the control unit 60 outputs and communicates an operation signal to a warning light 62. The warning light 62 lights up when a leak is detected by the leakage diagnosis so as to warn the driver that there is a leak.

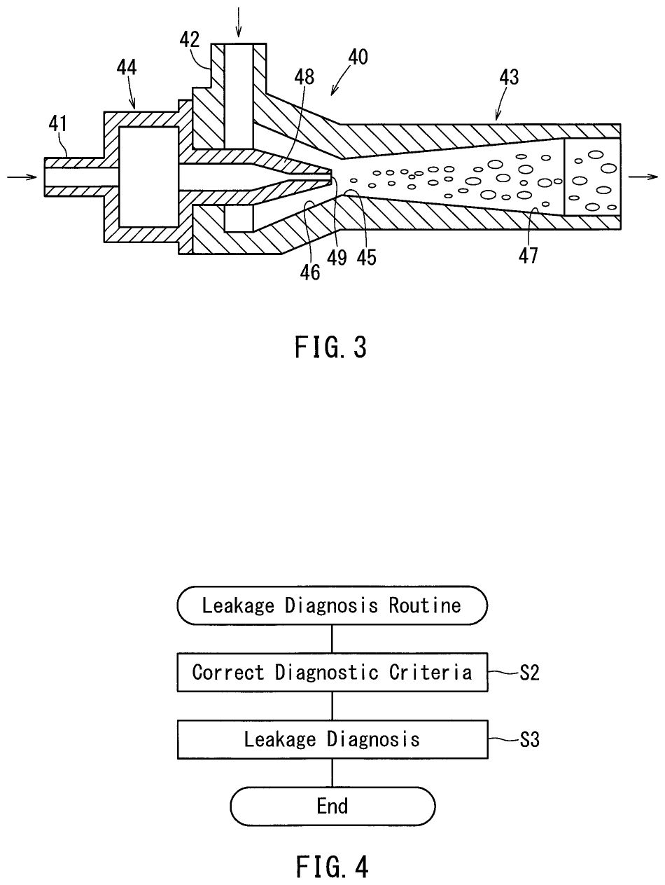

FIG. 3 illustrates the aspirator 40. In this embodiment, the aspirator 40 includes a venturi part 43 and a nozzle part 44. Fuel flows at a relatively high rate from the nozzle part 44 to the venturi part 43. The fuel is emitted from the venturi part 43 back into the fuel tank 2. The venturi part 43 includes a flow constriction 45, a decompression chamber 46, a diverging diffuser 47, and a suction port 42. The decompression chamber 46, which has a tapered shape that converges moving toward the flow constriction 45 is positioned on the upstream side of the flow constriction 45 relative to the fuel flow direction. The diffuser 47, which has an end-expanded shape, is positioned on the downstream side of the flow constriction 45 relative to the fuel flow direction. The suction port 42 extends from the decompression chamber 46. The decompression chamber 46, the flow constriction 45, and the diffuser 47 are coaxially aligned. The flow constriction 45 defines a narrow channel having a cross-sectional area that is narrower than that of the upstream and downstream sides in the fuel flow direction.

The suction port 42 is connected to the suction passage 54 (see FIG. 1). The nozzle part 44 is joined to the upstream side of the venturi part 43. The nozzle part 44 includes an introduction port 41 and a nozzle body 48. The introduction port 41 introduces fuel into the aspirator 40. The introduced fuel is then jetted from the nozzle body 48 into the venturi part 43. The nozzle body 48 extends into and is coaxially aligned with the decompression chamber 46. A jet port 49 of the nozzle body 48 is positioned near the flow constriction 45.

A portion of the fuel discharged from the fuel pump 8 may be introduced from the fuel supply passage 56 to the introduction port 41 via the branch passage 52 (see FIG. 1), thereby introducing the fuel into the aspirator 40. The introduced fuel jetted from the nozzle body 48 flows at a relatively high rate in the axial direction through the center of the flow constriction 45 and the diffuser 47. A negative pressure is generated in the decompression chamber 46 due to the Venturi effect induced by the flow of fuel. Accordingly, a suction force is generated in the suction port 42 and the suction passage 54 (see FIG. 1). The gas sucked by the suction port 42 via the suction passage 54 (fuel vapor and air from the canister 4) is mixed with the fuel injected from the nozzle body 48. The mixture is ejected from the diffuser 47 into the fuel tank 2.

There are several potential methods to diagnose a leak in the vapor path of fuel vapor treatment device such as fuel vapor path 30 of the fuel vapor treatment device shown in FIG. 1. Several methods will now be described.

In a first embodiment of a method to diagnose a leak, the shutoff valve 12 is opened and the atmosphere valve 16 is closed. Then, the purge valve 14 is opened. The leakage diagnosis is performed while the negative pressure generated by the engine 6 is introduced into the vapor path 30, which may include the canister 4 and the fuel tank 2. While introducing negative pressure into the vapor path 30, the pressure is detected by the pressure sensor 24. If the rate of the drop in the detected pressure is slower than a predetermined rate, the presence of a leakage can be determined.

In a second embodiment of a method to diagnose a leak, negative pressure is applied to the vapor path 30 in the same manner as described above in the first embodiment of the method. Then, the purge valve 14 is closed. Accordingly, the vapor path 30, including the canister 4 and the fuel tank 2, is closed. In such a state, the leakage diagnosis is performed. An increase in pressure after the vapor path 30 has been closed can be detected by the pressure sensor 24. If the rate of increase in the detected pressure is faster than a predetermined rate, the presence of a leakage can be determined.

In a third embodiment of a method to diagnose a leak, the purge valve 14 and the branch valve 20 are opened while the atmospheric valve 16 and the shutoff valve 12 are closed. Then, the negative pressure generated by the engine 6 is applied to the canister 4 at portions other than that corresponding to the shutoff valve 12. The air sucked by the aspirator 40 is introduced into the fuel tank 2 by means other than the shutoff valve 12. Then, a leakage diagnosis is performed. In this case, the leakage diagnosis is performed in two separate areas. The areas are divided into a first area on the side of the shutoff valve 12 including the canister 4 and a second area on the side of the shutoff valve 12 including the fuel tank 2. In the third embodiment of the method, the suction passage 54 may not be in fluid communication with the canister 4. Instead, the suction passage 54 may be opened to atmospheric pressure, thereby applying atmospheric pressure to the fuel tank 2. If the rate at which the negative pressure within the first area (on the side of the shutoff valve 12 including the canister 4) increases toward atmospheric pressure faster than a predetermined rate, the presence of a leakage can be detected. Further, if the rate at which the positive pressure within the second area (on the side of the shutoff valve 12 including the fuel tank 2) decreases toward atmospheric pressure faster than a predetermined speed, the presence of a leakage can be determined.

Another embodiment of a method to diagnose a leak may rely on, for example, the usage of a purgeless evaporative system. In a purgeless evaporative system, the processing of the evaporated fuel may not be performed by purging the engine 6. Instead, it may be performed by suctioning the aspirator 40. In particular, the fuel vapor, which is adsorbed in the canister 4, is sucked by the aspirator 40, and then returned to the fuel tank 2. In such method, some leakage diagnosis can be performed in the same way as the third embodiment of the method described above via a negative pressure on the side of the shutoff valve 12 including the canister 4 and a positive pressure on the side of the shutoff valve 12 including the fuel tank 2 by operating the aspirator 40.

The control unit 60 (see FIG. 2) of the embodiment of the leakage detector described above and shown in FIG. 1 may perform the leakage diagnosis of the vapor path 30 according to an embodiment of a method shown in the flowchart of a leakage diagnosis routine in FIG. 4. First, the diagnostic criteria for indicating leakage are corrected in Step S2. Specifically, the higher the saturated vapor pressure of the fuel vapor in the gas space of the fuel tank 2, the greater the amount the diagnostic criteria is corrected. The correction amount can be based on a map of saturated fuel vapor pressure and correction values. In Step S3, the leakage diagnosis is performed using one of the embodiments of methods described above.

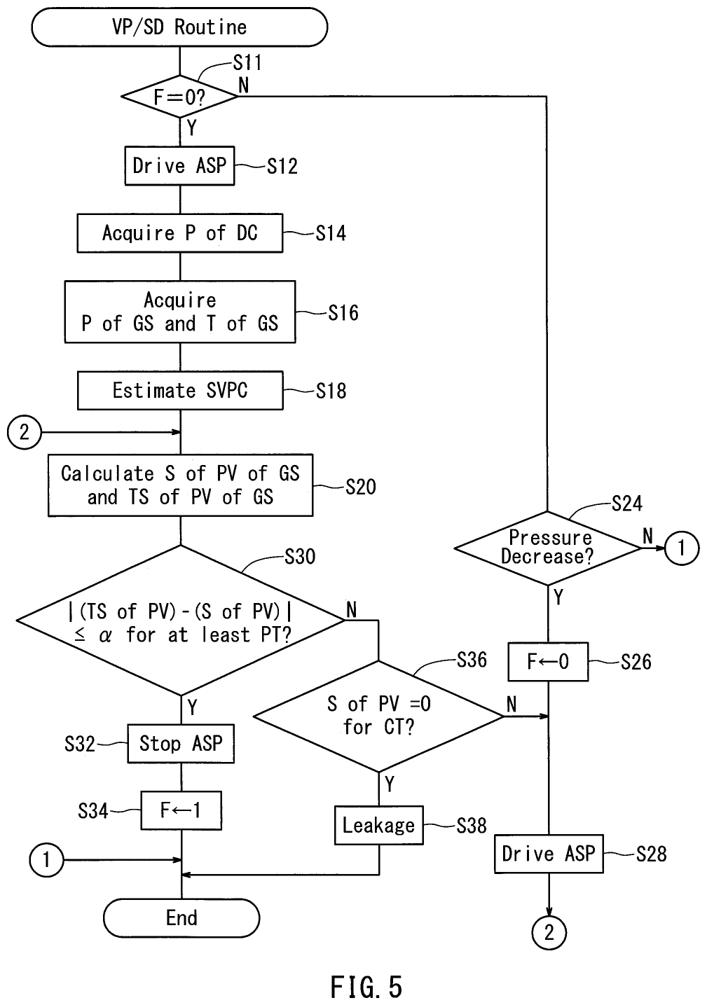

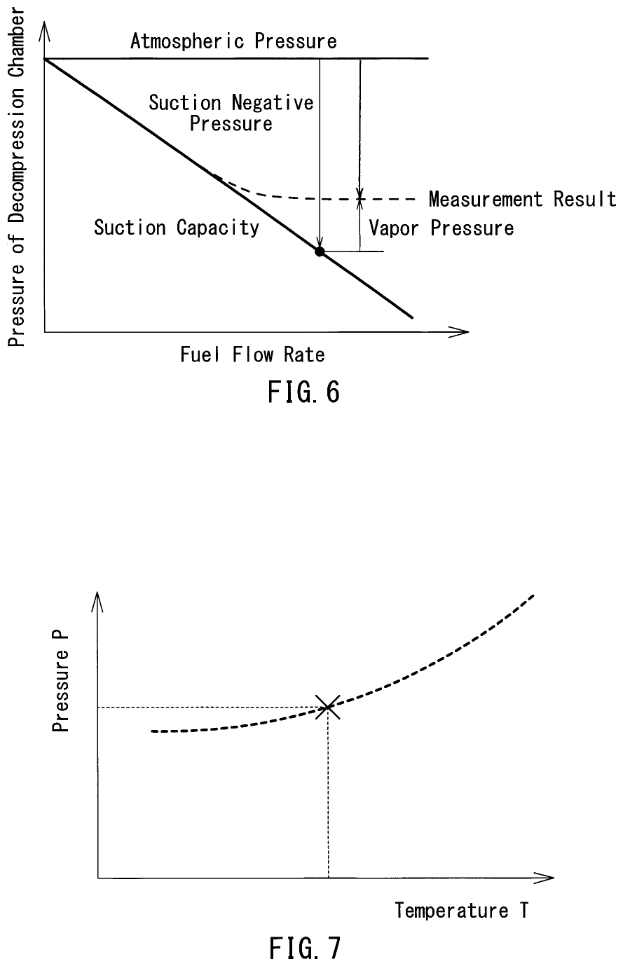

FIG. 5 shows an embodiment of the vaporization promotion and saturation determination routine (also referred to as “VP/SD Routine” in the figures). The contents of FIG. 5 will be explained with reference to FIGS. 1 to 3. First, at Step S11, it is determined whether a flag F, which stores the fact that Step S30 described below has been determined to be Yes, is in the reset state (not in the storage state or set to a value indicating the reset state). Initially, the flag F is in the reset state; so Step S11 is determined to be Yes. At Step S12, the aspirator (ASP) 40 is driven or operated. At Step S14, the pressure of the decompression chamber 46 (also referred to as “P of DC” in the figures) of the aspirator 40 is detected by the pressure sensor 26 and acquired. At Step S16, the temperature of the gas space in the fuel tank 2 (also referred to as “T of GS” in the figures) and the pressure of the gas space in the fuel tank 2 (also referred to as “P of GS” in the figures are detected by the temperature sensor 22 and the pressure sensor 24, respectively, and acquired. At Step S18, the saturated vapor pressure characteristic of the fuel in the fuel tank 2 (also referred to as “SVPC” in the figures) is estimated based on the pressure of the decompression chamber 46. It should be appreciated that the decompression chamber 46 is saturated with fuel vapor when the aspirator 40 is in a steady state of operation. The negative pressure of the decompression chamber 46 (suction negative pressure) due to the fuel flow therethrough can be calculated from the amount of fuel supplied from the fuel pump 8 to the aspirator 40. The possible values of the negative pressure of the decompression chamber 46 can be provided in advance. Therefore, as shown in FIG. 6, the saturated vapor pressure (vapor pressure) can be calculated from the difference between the suction negative pressure and the pressure actually detected by the pressure sensor 26 (measurement result). As shown in FIG. 7, the characteristic, which corresponds to a point where the vapor pressure matches the temperature, is identified as shown by the dashed line among a plurality of saturated vapor pressure characteristics stored in advance based on the temperature and saturated vapor pressure of the gas space in the fuel tank 2. Instead of the temperature of the gas space in the fuel tank 2, the temperature of the decompression chamber 46 may be used, which may be detected by another temperature sensor.

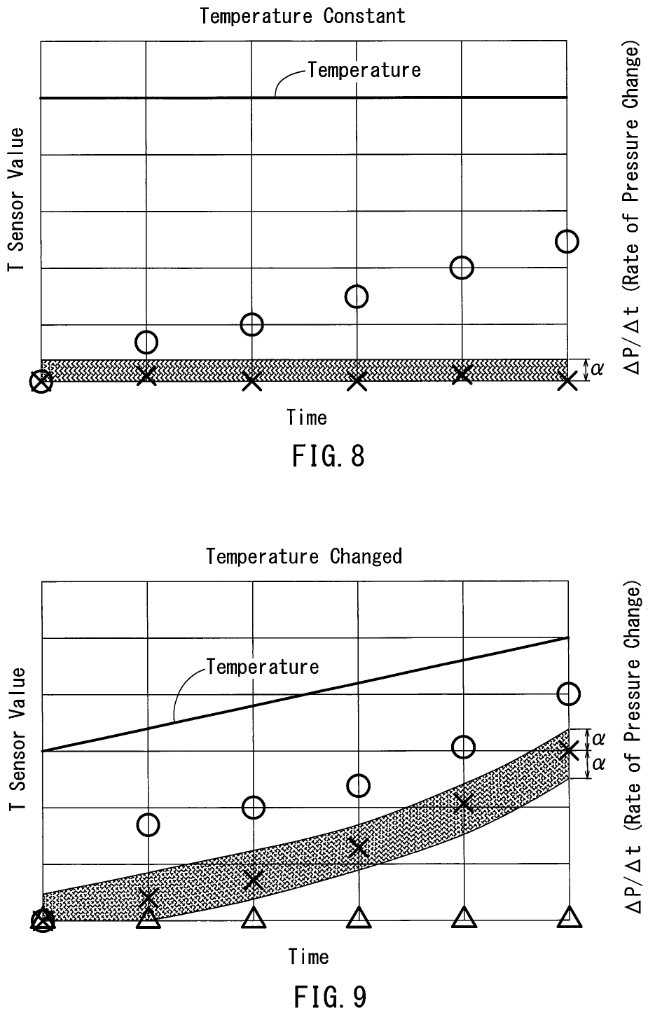

Referring again to FIG. 5, at Step S20, the rate of the pressure change of the gas space in the fuel tank 2 (also referred to as “S of PV of GS” in the figures), which may be determined using the pressure detected by the pressure sensor 24, is calculated. Also at Step 20, the target rate of the pressure change of the same gas space (also referred to as “TS of PV of GS” in the figures) in the state where the fuel vapor is saturated is calculated. The target rate of the pressure change is calculated based on the saturated vapor pressure characteristic estimated at Step S18, and corrected for any temperature variation detected by the temperature sensor 22. In FIG. 8, the target rate of the pressure change, which in this example is when the temperature does not change, is indicated by X marks (X). The shaded area indicates an acceptable range of target rates of the pressure change (corresponding to the threshold a described below). Circle marks (0) indicate a pressure change when the fuel vapor is non-saturated, which may cause the pressure to gradually increase due to vaporization. FIG. 9 shows the same target rate of the pressure change as in FIG. 8, but with a change in temperature. In this case, the target rate of the pressure change also increases as the temperature increases. In FIG. 9, triangle marks (A) indicates the pressure change in a state where the pressure does not increase due to a large hole in the vapor path 30, even though the temperature is increasing.

Referring again to FIG. 5, at Step S30, it is determined whether the difference (absolute value) between the target rate of the pressure change and the actual rate of the pressure change of the gas space is within a threshold a. If it is within the threshold a (also referred to as “a” in the figures), Step S30 also determines whether the condition has continued for at least a predetermined time (also referred to as “PT” in the figures) (e.g., about 10 seconds or more). In other words, it is determined whether the rate of the pressure change of the gas space has been within the shaded range, for instance as shown in FIGS. 8 and 9, for the predetermined time or more. If Step S30 is determined to be Yes, the fuel vapor in the gas space of the fuel tank 2 is considered to be saturated and the operation of the aspirator 40 is stopped at Step S32, as further vaporization promotion is unnecessary. At Step S34, the flag F is set because Step S30 has been determined to be Yes. Then, the process of the vaporization promotion and saturation determination routine is finished.

If Step S30 is determined to be No, it is determined at Step S36 whether the rate of the pressure change in the gas space is zero for a certain period of time (also referred to as “CT” in the figures) (e.g., about 5 seconds). If the rate of the pressure change of the gas space is zero and not within a certain threshold, for instance the state indicated by the triangles (A) in FIG. 9, Step S36 is determined to be Yes. At Step S38, it is recorded in the memory associated with the control unit 60 that a large leakage is occurring due to a large hole in the vapor path 30. At Step S36, a leakage may also be determined if the rate of the pressure change of the gas space is below a certain value, including zero.

After Step S38, the process of the vaporization promotion and saturation determination routine is finished (end). If Step S36 is determined to be No, the aspirator 40 is further driven and operated to promote vaporization of the fuel in the fuel tank 2. That is, the fuel pump 8 is activated and the branch valve 20 is opened to allow fuel to flow through the aspirator 40. After Step S28, the process returns to Step S20. The rate of the pressure change of the gas space in the fuel tank 2 as detected by the pressure sensor 24 and the target rate of the pressure change of the same gas space if the fuel vapor were to be saturated is calculated again. Then, the process from Step S30 onward is repeated.

If it were to be initially determined that the fuel vapor in the gas space of the fuel tank 2 is saturated, for instance if the flag F is in the set state, it is determined to be No at Step S11. The process can determine at Step S24 whether the pressure of the gas space has decreased. For instance, it is determined whether saturation state is maintained and if the pressure decreases after the fuel vapor in the gas space has become saturated. If Step S24 is determined to be Yes, the flag F is reset at Step S26, which indicates that the saturated state has not been maintained. Next, in Step S28, the aspirator 40 is driven and operated to promote vaporization in the fuel tank 2 again. Thereafter, the process from Step S20 onward is repeated. If Step S24 is determined to be No, the process of the vaporization promotion and saturation determination routine is finished as the saturation state of fuel vapor is maintained. At Step S24, although the determination of whether the fuel vapor saturation is maintained is based on whether the pressure of the gas space is decreasing, it may instead or additionally be determined by whether the fuel vapor concentration is maintained at a predetermined concentration.

By executing the process of the vaporization promotion and saturation determination routine according to the embodiment shown in FIG. 5 and described above, the aspirator 40 is activated to promote vaporization of the fuel in the fuel tank 2, thereby saturating the fuel vapor in the gas space of the fuel tank 2 at an early stage. After saturation, the diagnostic criteria for leakage diagnosis is corrected based on the saturated vapor pressure. This is done at Step S2 of the leakage diagnostic routine in FIG. 4. Then, the leakage diagnosis is performed at Step S3. Therefore, it is possible to avoid performing the leakage diagnosis in a non-saturated state. As a result, the diagnostic accuracy may be improved. Instead of determining the saturation state based on vapor pressure, the saturation state may instead or additionally be determined based on the concentration of the fuel vapor. However, if the saturation state is to be determined based on the concentration of the fuel vapor, a concentration meter may be required. In contrast, the first embodiment shown in FIG. 5 has the advantage of not requiring a concentration meter because the saturation state is to be determined based on vapor pressure. In addition, in the process of determining whether the vapor is saturated, it is also possible to detect if there is a large hole in the vapor path 30. If it is determined that there is a large leakage at Step S38 of FIG. 5, and/or it is determined that there is a leakage at Step S3 of FIG. 4, a warning light 62 (see FIG. 2) is turned on when the engine 6 is started, thereby warning the driver that there is a leakage in the vapor path 30.

In a second embodiment of a vaporization promotion and saturation determination routine, the pressure regulator 10 is used as the vaporization promoting device. This is in contrast to the aspirator 40 being used as the vaporization promoting device in the first embodiment shown in FIG. 5. In order to use the pressure regulator 10 as the vaporization promoting device, the pressure regulator 10 is operated in a similar way to the aspirator 40 of the first embodiment shown in FIG. 5. Accordingly, the fuel pump 8 may be operated even when the engine 6 is stopped. In addition, even if the engine 6 is idling and the fuel consumption is low, the fuel pump 8 may be operated to supply fuel that exceeds the current fuel consumption. Therefore, in the second embodiment, the fuel pump 8 is operated (or the operating output is increased) at Steps S12 and S28 of FIG. 5, and the fuel pump 8 is stopped (or the operating output is decreased) at Step S32.

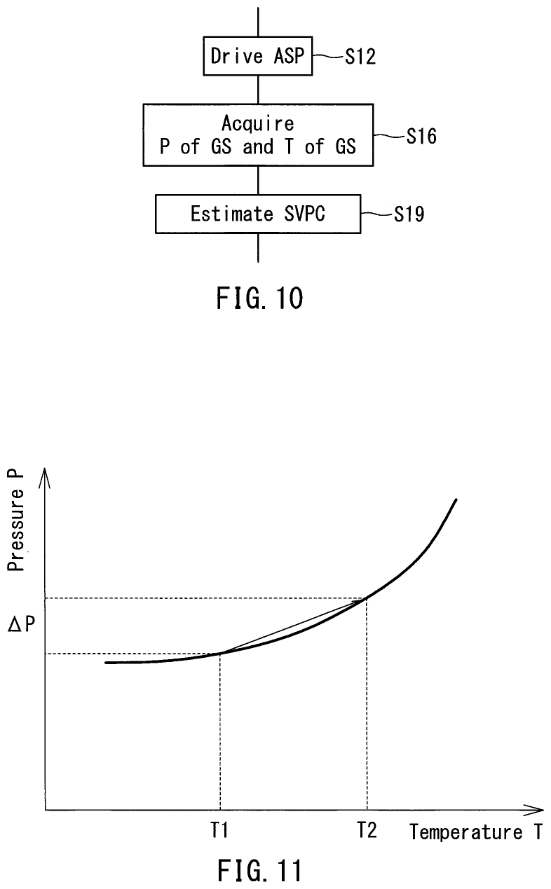

FIG. 10 is a flowchart illustrating steps of the control unit 60 for controlling and operating a third embodiment of a vaporization promotion and saturation determination routine. FIG. 10 shows only the parts that are more substantially changed from the first embodiment shown in FIG. 5. In the “vaporization promotion and saturation determination routine,” the aspirator 40 is driven at Step S12. Then, the pressure and the temperature of the gas space in the fuel tank 2 are acquired at Step S16. At Step S19, the saturated vapor pressure characteristics are estimated as described below.

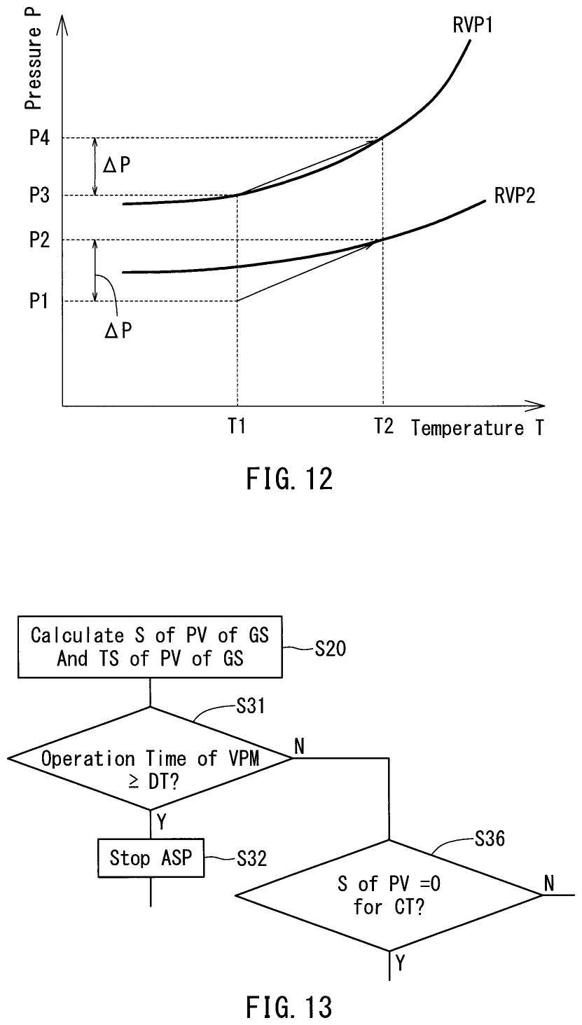

First, as shown in FIG. 11, the pressure change of the gas space (ΔP) with regards to the temperature change of the gas space (T1 to T2) is calculated. Then, a comparison of the pressure change of the gas space (ΔP) with regards to the temperature change of the gas space (T1 to T2) against a plurality of saturated vapor pressure curves stored in advance, as shown in FIG. 12, is performed. It is determined whether any of the plurality of saturated vapor pressure curves matches the pressure change of the gas space (ΔP) with regards to the temperature change of the gas space (T1 to T2). If there is a matching saturated vapor pressure curve, the characteristics of this saturated vapor pressure curve is identified as the saturated vapor pressure characteristics. If there is no matching saturated vapor pressure curve, it is determined that the saturated state has not yet been reached, and the process is repeated until a matching saturated vapor pressure curve is identified.

In the example shown in FIG. 12, when the pressure change of the gas space ΔP with regards to the temperature change of the gas space (T1 to T2) corresponds to pressures P3 to P4, the curve essentially matches the curve of a saturated vapor pressure characteristic RVP1. This is especially the case if a certain threshold or tolerance is taken into consideration. Therefore, the saturated vapor pressure characteristic is identified as that corresponding to RVP1. On the other hand, if the pressure change of the gas space ΔP with regards to the temperature change of the gas space (T1 to T2) corresponds to pressures P1 to P2, the curve does not match the curve of a saturated vapor pressure characteristic RVP2. Therefore, an appropriate saturated vapor pressure characteristic cannot be identified at this time.

According to the third embodiment shown in FIG. 10, the pressure sensor 26 for the decompression chamber 46 of the aspirator 40 may be omitted, as compared to the first embodiment shown in FIG. 5. This is because there is no need to detect the pressure of the decompression chamber 46 of the aspirator 40 for this purpose.

FIG. 13 is a flowchart illustrating steps of the control unit 60 for controlling and operating a fourth embodiment of a vaporization promotion and saturation determination routine. FIG. 13 shows only the parts that are substantially changed from the first embodiment shown in FIG. 5. After the process of Step S20, Step S31 determines whether the operation time of the aspirator 40, which is partially functioning as the vaporization promoting device (also referred to as “VPM” in the figures), has elapsed for a predetermined detecting time (also referred to as “DT” in the figures) (e.g., about 3 minutes) or more since the process of the “vaporization promotion and saturation determination routine” has started. The detecting time is determined based on the operating output of the aspirator 40, which in this embodiment is the vaporization promoting device, and the volume of the gas space in the fuel tank 2. The operating output of the aspirator 40 is determined by the amount of fuel supplied to the aspirator 40 from the fuel pump 8. The volume of the gas space in the fuel tank 2 is determined by the difference between the capacity of the fuel tank 2 and the amount of fuel remaining in the fuel tank 2.

If the detecting time has elapsed, it is determined to be Yes at Step S31. Accordingly, the process may assume that the fuel vapor has reached the saturated state based on the elapsed time. Then, the operation of the aspirator 40 is stopped in Step S32. If the detection time has not elapsed, it is determined to be No at Step S31. Then, the process from Step S36 onwards is performed.

According to the fourth embodiment shown in FIG. 13, the determination of whether the fuel vapor has reached the saturated state is simpler than the first embodiment shown in FIG. 5. Therefore, the program may be simplified and the processing rate may be accelerated.

In the flowcharts of FIGS. 5 and 13, the Steps S30 and S31 correspond to the saturation detection means or step in the present disclosure. The Step S24 corresponds to the saturation maintenance detection means or step in the present disclosure. The Steps S30 and S36 and the Steps S31 and S36 correspond to the leakage detecting means or steps in the present disclosure.

Although the present disclosure has been described in terms of specific embodiments, it may be implemented in various other forms. For example, the second, third, and/or fourth embodiments may replace a part of the first embodiment, or a part of the first embodiment may be replaced with an appropriate combination of the second, third, and fourth embodiments.

The various examples described above in detail with reference to the attached drawings are intended to be representative of the present disclosure and are thus non-limiting embodiments. The detailed description is intended to teach a person of skill in the art to make, use, and/or practice various aspects of the present teachings, and thus does not limit the scope of the disclosure in any manner. Furthermore, each of the additional features and teachings disclosed above may be applied and/or used separately or with other features and teachings in any combination thereof, to provide an improved leakage detector for fuel vapor treatment devices, and/or methods of making and using the same.

What is claimed is:

1. A leakage detector for a fuel vapor treatment device, comprising:
a fuel tank;
a canister configured to adsorb and capture a fuel vapor from the fuel tank, wherein the fuel vapor treatment device is configured to allow the captured fuel vapor in the canister to be sucked into an engine or to be returned to the fuel tank;
a vapor path including the fuel tank and the canister, wherein the vapor path confines the fuel vapor from the atmosphere;
a vaporization promoting device configured to promote vaporization of fuel in the fuel tank; and
a control unit configured to:
determine whether the fuel vapor in a gas space of the fuel tank has reached a saturated state, wherein:
activate the vaporization promoting device if the fuel vapor is determined not to have reached the saturated state;
conduct a leakage diagnosis of the vapor path after determining that the fuel vapor has reached the saturated state;
;
detect leakage of the fuel vapor from the vapor path based on an internal pressure change of the vapor path with the vapor path being placed in a closed space state; and
correct an effect of the pressure of the fuel vapor with regard to the internal pressure change.

2. The leakage detector for the fuel vapor treatment device of claim 1, wherein the control unit is configured to:
determine whether the fuel vapor in the gas space of the fuel tank has reached the saturated state based on physical characteristics that change with promotion of the fuel vaporization in the fuel tank.

3. The leakage detector for the fuel vapor treatment device of claim 2, further comprising a pressure sensor configured to detect the pressure in the gas space of the fuel tank, wherein the control unit is configured to:
compare a rate of pressure change detected by the pressure sensor to a target rate of pressure change; and
determine that the fuel vapor in the gas space of the fuel tank is in the saturated state if the difference between the rate of the pressure change and the target rate of the pressure change is within a threshold value for at least a predetermined time.

4. The leakage detector for the fuel vapor treatment device of claim 3, further comprising a temperature sensor configured to detect the temperature of the fuel vapor in the gas space of the fuel tank, wherein:
the target rate of the pressure change of the fuel vapor is set via a saturated vapor pressure characteristic that represents the change of the fuel vapor pressure with regard to a temperature change when the fuel vapor in the fuel tank is in the saturated state and the temperature change is detected by the temperature sensor.

5. The leakage detector for the fuel vapor treatment device of claim 4, further comprising:
a fuel pump configured to supply fuel from the fuel tank to the engine; and
an aspirator configured to direct the fuel from the fuel pump to flow at an increased flow rate to a narrow channel whose passage cross-sectional area is narrower than that of an upstream side and a downstream side, thereby generating a negative pressure in a decompression chamber around the narrow channel by the Venturi effect;
wherein the saturated vapor pressure characteristic is estimated via the pressure of the fuel vapor in the saturated state obtained by an internal pressure in the decompression chamber of the aspirator and the temperature detected by the temperature sensor.

6. The leakage detector for the fuel vapor treatment device of claim 4, wherein:
the saturated vapor pressure characteristic is estimated by using the temperature detected by the temperature sensor and the pressure detected by the pressure sensor, and
the saturated vapor pressure characteristic is estimated by comparing the pressure change associated with the temperature change of the fuel vapor in the gas space of the fuel tank with a plurality of saturated vapor pressure characteristics stored in advance.

7. The leakage detector for the fuel vapor treatment device according to claim 1, wherein the control unit is configured to:
determine whether the fuel vapor has reached the saturated state by determining whether a predetermined detecting time has elapsed since activating the vaporization promoting device, wherein the predetermined detecting time is determined based on an output of the vaporization promoting device and the volume of the gas space of the fuel tank.

8. The leakage detector for the fuel vapor treatment device of claim 1, wherein the control unit is configured to:
determine whether the saturation state is maintained based on physical characteristics that vary depending on the state of fuel vaporization in the fuel tank after the fuel vapor has been determined to be in the saturated state; and
activate the vaporization promoting device if the saturation state is determined not to be maintained.

9. The leakage detector for the fuel vapor treatment device of claim 1, wherein:
the vaporization promoting device comprises a pressure regulator configured to return a surplus fuel of fuel supplied from the fuel tank to the engine by a fuel pump to the fuel tank.

10. The leakage detector for the fuel vapor treatment device of claim 1, wherein:
the vaporization promoting device comprises an aspirator configured to cause fuel supplied from the fuel tank toward the engine by a fuel pump to flow through a narrow channel whose passage cross-sectional area is narrower than that of an upstream side at an increased flow rate and is returned to the fuel tank, thereby generating a negative pressure in a decompression chamber around the narrow channel due to the Venturi effect.

11. The leakage detector for the fuel vapor treatment device of claim 3, wherein the control unit is configured to:
determine that there is a leakage of evaporated fuel in the vapor path when the fuel vapor is in a non-saturated state and the rate of the pressure change of the fuel vapor pressure detected by the pressure sensor remains below a certain value for a certain period of time.
